(19) United States
(12) Patent Application Publication
(10) Pub. No.: US 2026/0301374 A1
(43) Pub. Date: Oct. 1, 2026

(54) OBJECT DETECTION FOR VIDEO APPLICATIONS

(71) Applicant: Microsoft Technology Licensing, LLC, Redmond, WA (US)

(72) Inventors: Qi ZHANG, Gig Harbor, WA (US); Fuxun YU, Redmond, WA (US); Rishi MADHOK, Renton, WA (US); Nikolaos KARIANAKIS, Sammamish, WA (US)

(73) Assignee: Microsoft Technology Licensing, LLC, Redmond, WA (US)

(21) Appl. No.: 19/092,595

(22) Filed: Mar. 27, 2025

(51) Int. Cl. G06V 10/77; G06V 10/82; G06V 20/40

(52) U.S. Cl. CPC G06V 10/7715; G06V 10/82; G06V 20/46

(57) ABSTRACT

This document relates to detecting objects in videos. Objects can be difficult to detect in videos due to motion blur, occlusion, and/or having a relatively small size. The disclosed techniques can assign frames of a video to respective subnetworks of a machine learning model. Visual features of the frames can be processed by the subnetworks together with temporal features propagated from preceding subnetworks. The final features produced by the machine learning model can be employed for tasks such as video classification, object detection, and/or semantic segmentation.

### BACKGROUND

One important application of machine learning involves detecting objects in videos. One way to detect objects in a video is to input each frame of the video to a machine learning model designed for static images, which can then process each frame independently as a static image. However, this approach can lack temporal consistency across video frames and can also fail to capture temporal information relating to motion of objects across frames.

### SUMMARY

This Summary is provided to introduce a selection of concepts in a simplified form. These concepts are further described below in the Detailed Description. This Summary is not intended to identify key features or essential features of the claimed subject matter, nor is it intended to be used to limit the scope of the claimed subject matter.

The description generally relates to techniques for object detection using a machine learning model. One example includes a computer-implemented method that can include obtaining video frames of a video. The method can also include assigning individual video frames of the video to respective subnetworks of a machine learning model. The method can also include extracting initial features from respective video frames of the video. The method can also include inputting the initial features to respective assigned subnetworks of the machine learning model. The method can also include propagating intermediate features among the subnetworks. The method can also include obtaining final features produced by a final subnetwork of the machine learning model. The method can also include processing the final features using the machine learning model to produce a result. The method can also include outputting the result.

Another example entails a system that includes a processor and a storage medium storing instructions. When executed by the processor, the instructions can cause the system to obtain video frames of a video. The instructions can also cause the system to assign individual video frames of the video to respective subnetworks of a machine learning model. The instructions can also cause the system to extract initial features from respective video frames of the video. The instructions can also cause the system to input the initial features to respective assigned subnetworks of the machine learning model. The instructions can also cause the system to propagate intermediate features among the subnetworks. The instructions can also cause the system to obtain final features produced by a final subnetwork of the machine learning model. The instructions can also cause the system to process the final features using the machine learning model to produce a result. The instructions can also cause the system to output the result.

Another example includes a computer-readable storage medium storing executable instructions which, when executed by a processor, cause the processor to perform acts. The acts can include obtaining video frames of a video. The acts can also include assigning individual video frames of the video to respective subnetworks of a machine learning model. The acts can also include extracting initial features from respective video frames of the video. The acts can also include inputting the initial features to respective assigned subnetworks of the machine learning model. The acts can also include propagating intermediate features among the subnetworks. The acts can also include obtaining final features produced by a final subnetwork of the machine learning model. The acts can also include processing the final features using the machine learning model to produce a result. The acts can also include outputting the result.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. The use of similar reference numbers in different instances in the description and the figures may indicate similar or identical items.

FIG. 1A illustrates an example object detection model, consistent with some implementations of the present concepts.

FIG. 1B illustrates an example of cross-level fusion, consistent with some implementations of the present concepts.

FIGS. 2A, 2B, 2C, 2D, and 2E illustrate frames from an example video, consistent with some implementations of the present concepts.

FIGS. 3A, 3C, 3E, and 3G illustrate examples of individual frames being processed by assigned subnetworks, consistent with some implementations of the present concepts.

FIGS. 3B, 3D, 3F, and 3H illustrate example contents of a memory buffer when processing video frames, consistent with some implementations of the present concepts.

FIG. 4 illustrates an example of a system in which the disclosed implementations can be performed, consistent with some implementations of the disclosed techniques.

FIG. 5 illustrates an example of a method consistent with some implementations of the present concepts.

### DETAILED DESCRIPTION

### Overview

As noted above, one way to detect objects in videos involves independently processing one or more frames of the video using a machine learning model designed to recognize objects in static images. While this approach can work well under certain circumstances, it can result in inconsistent detections across frames. Furthermore, videos include temporal information relating to movement of objects across frames, and static image processing models fail to consider this temporal information.

Other approaches for detecting objects in videos involve using machine learning models that are explicitly designed for video. For instance, optical flow methods, temporal aggregation methods, and feature propagation methods can consider temporal information to some extent. However, these methods tend to have various drawbacks such as high computational cost, high memory utilization, and/or low accuracy.

The disclosed implementations offer low-latency, memory efficient, and highly accurate techniques for recognizing objects in videos. For instance, the disclosed techniques can assign individual frames of a video to different subnetworks of a machine learning model. Each subnetwork can process visual features extracted from its assigned video frame, while propagating temporal information to subsequent subnetworks that have been assigned to process subsequent video frames. By propagating temporal information from one subnetwork to the next, the machine learning model can learn to recognize objects not only using the visual features of its assigned frame, but also the temporal information propagated among the subnetworks.

### Machine Learning Overview

There are various types of machine learning frameworks that can be trained to perform a given task. Support vector machines, decision trees, Kolmogorov-Arnold networks, state space models, and neural networks are just a few examples of machine learning frameworks that have been used in a wide variety of applications, such as image processing, computer vision, and natural language processing. The term “machine learning model” refers to a model that is trained using training data to adjust parameters of the model. In some cases, a machine learning model can be trained using labeled training data, a reward function, or other mechanisms, and in other cases, a machine learning model can learn by analyzing data without explicit labels or rewards.

Some machine learning frameworks, such as neural networks, use layers of nodes that perform specific operations. In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “parameters” when used without a modifier is used herein to refer to learnable values such as edge weights and bias values that can be learned by training a machine learning model, such as a neural network.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “subnetwork” refers to a portion of a machine learning such as a neural network.

The term “trained model” and/or “tuned model” refers to a model structure together with parameters for the model structure that have been trained or tuned. Note that two trained models can share the same model structure and yet have different values for the parameters, e.g., if the two models are trained on different training data or if there are underlying stochastic processes in the training process.

There are many machine learning tasks for which there is a relative lack of training data. One broad approach to training a model with limited task-specific training data for a particular task involves “transfer learning.” In transfer learning, a model is first pretrained on another task for which significant training data is available, and then the model is tuned to the particular task using the task-specific training data.

The term “pretraining,” as used herein, refers to model training on a set of pretraining data to adjust model parameters in a manner that allows for subsequent tuning of those model parameters to adapt the model for one or more specific tasks. In some cases, the pretraining can involve a self-supervised learning process on unlabeled pretraining data, where a “self-supervised” learning process involves learning from the structure of pretraining examples, potentially in the absence of explicit (e.g., manually-provided) labels. Subsequent modification of model parameters obtained by pretraining is referred to herein as “tuning.” Tuning can be performed for one or more tasks using supervised learning from explicitly-labeled training data, in some cases using a different task for tuning than for pretraining.

### Terminology

The term “initial features,” as used herein, refers to features obtained by processing a frame of a video for subsequent processing by one or more subnetworks of a machine learning model. For instance, initial features can represent visual characteristics of a video frame. Initial features can be obtained by processing the video frame using a stem layer. A “stem layer” is a layer of a machine learning model that processes raw image data, such red, green, and blue pixel data.

The term “intermediate features” refers to features shared among individual subnetworks of a machine learning model. For instance, intermediate features can represent temporal information corresponding to movement of objects in a video. Intermediate features can be propagated at varying levels of resolution among subnetworks assigned to respective frames of a video. For instance, a subnetwork can have multiple levels, each of which outputs intermediate features that can vary in resolution by level.

The term “final features” refers to features produced by a machine learning model that are processed by one or more other layers to produce a final result, such as an object detection. For instance, in some cases, final features can be produced by the final subnetwork that is assigned to the final frame of the video that is input to the machine learning model. However, the term “final features” could also encompass intermediate features produced by earlier subnetworks if those intermediate features are also used by one or more other layers to produce the result.

In reference to levels within a given subnetwork, the term “lower” refers to a level of a subnetwork that processes initial or intermediate features before another level of the same subnetwork. The term “higher” refers to a level of that subnetwork that receives intermediate features that have been processed by a prior (e.g., lower) level of the same subnetwork. In reference to features, the term “higher” refers to more abstract features that represent shapes, objects semantics, etc., while the term “lower” refers to features that represent basic image characteristics such as edges, corners, color, patterns, etc. Thus, for example, a given level of a given subnetwork may receive lower-level features from a preceding lower level and produce higher-level features that are provided to a subsequent higher level of the same subnetwork.

### Example Model Structure Overview

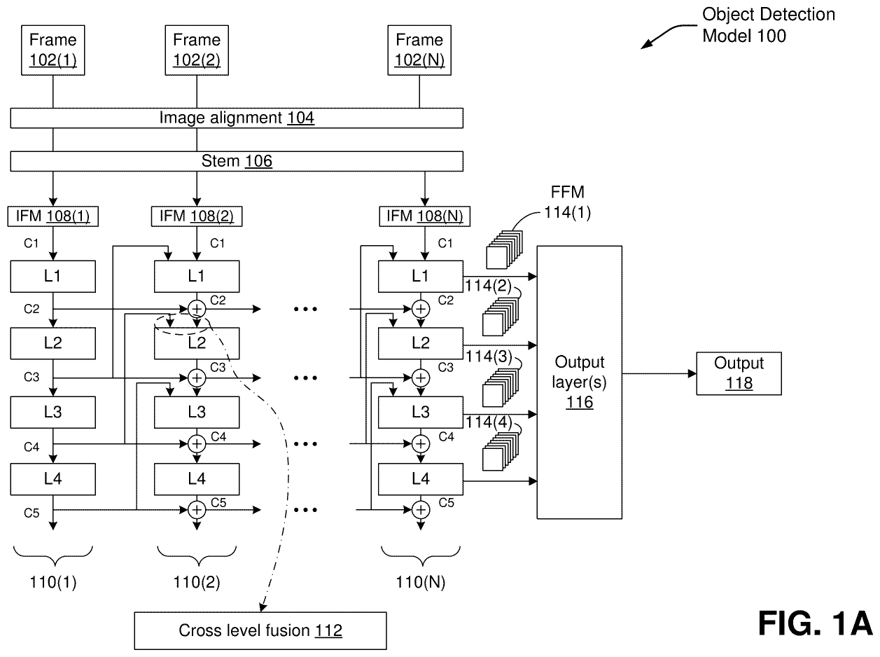

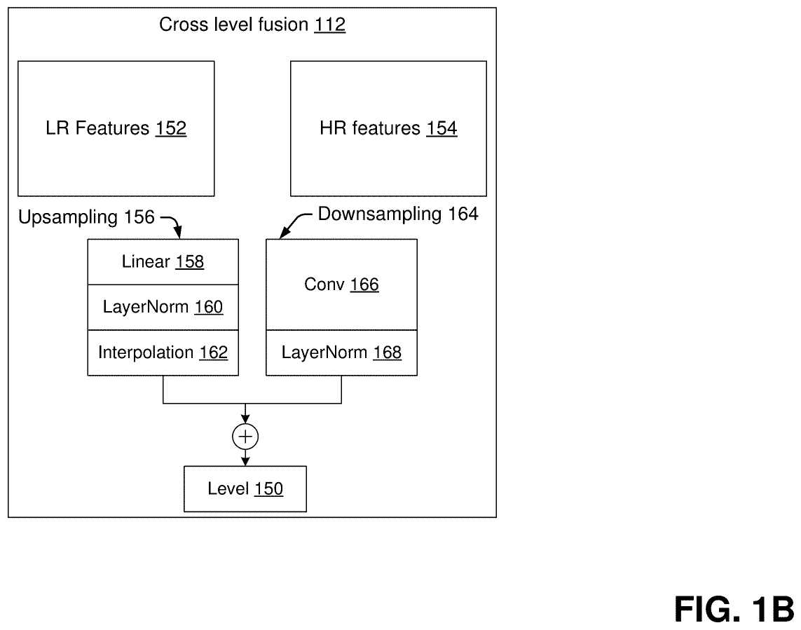

FIG. 1A shows an example object detection model 100 consistent with the disclosed implementations. Frame 102(1), frame 102(2), and so on through 102(N) are obtained from a video. Each of these frames is then input to image alignment 104, which spatially aligns each frame relative to some spatial reference. The resulting aligned frames that are processed by stem layer 106, which produces initial feature map 108(1) from frame 102(1), initial feature map 108(2) from frame 102(2), and so on through initial feature map 108(N) from frame 102(N).

Each of the initial feature maps can be processed by a corresponding subnetwork that is assigned to the corresponding frame represented by that initial feature map. For example, FIG. 1A shows a subnetwork 110(1) that processes initial feature map 108(1) representing frame 102(1), a subnetwork 110(2) that processes initial feature map 108(2) representing frame 102(2), and a subnetwork 110(N) that processes initial feature map 108(N) representing frame 102(N). Within each subnetwork, the level numbers increase as the levels get higher and produce relatively higher-level features. Thus, for instance, level 4 of a given subnetwork is higher than level 3 and generally produces higher-level features than level 3, level 3 is higher than level 2 and produces higher-level features than level 2, and so on. In addition, in some implementations, intermediate features can be downsampled to lower resolutions as the intermediate features move to higher levels of the subnetwork.

In the example shown in FIG. 1A, each subnetwork is implemented as a column having four levels—level L1, level L2, level L3, and level L4. Adjacent columns have connections at multiple levels that facilitate feature propagation across subnetworks, implicitly encoding temporal information to improve learning in subsequent columns. The resulting final feature maps output by the final subnetwork 110(N) include final feature map 114(1), final feature map 114(2), final feature map 114(3), and final feature map 114(4). These final feature maps can be employed for downstream tasks such as classification, object detection, and/or semantic segmentation using output layer(s) 116 to produce an output 118. Note that each individual subnetwork also produces intermediate features not shown in FIG. 1A due to space constraints.

In addition, as described more, below reversible connections can be employed between adjacent subnetworks. The connections between the subnetworks can also employ cross-level fusion 112. Cross-level fusion can involve propagating intermediate features from one level of one subnetwork to a different level of another (e.g., subsequent) subnetwork.

FIG. 1B shows additional details on cross-level fusion by a given level 150 of a current subnetwork. Low resolution features 152 from a previous frame are received from a higher-level layer of a preceding subnetwork. High resolution features 154 of current frame are obtained from a lower-level layer of the current subnetwork.

The low resolution features 152 can be processed by upsampling 156 using a linear layer 158, a LayerNorm layer 160, and an interpolation layer 162. The linear layer can be a fully-connected layer that performs a linear transformation on the low resolution features. The LayerNorm layer can normalize activations of the transformed features statistically, e.g., using a mean, standard deviation, etc. The interpolation layer can determine values for “missing” features in the low resolution features based on neighboring features and can output the interpolated features for processing by a lower level of a subsequent subnetwork.

The high resolution features 154 can be processed by downsampling 164 using a convolutional layer 166 and a LayerNorm layer 168. The convolutional layer can process the high resolution features using a sliding window that uses specified a stride, resulting in downsampling of the high resolution features. The LayerNorm layer 168 can perform similar functionality to LayerNorm layer 160, by normalizing activation of the downsampled features produced by the convolutional layer.

The values output by upsampling 156 and downsampling 164 can be summed together to determine the feature maps output by level 150 to other levels and/or subnetworks. For instance, referring back to FIG. 1A, level 3 of subnetwork 110(1) can receive intermediate features at a given resolution from level 2 of subnetwork 110(1). These intermediate features can be processed and then propagated to level 2 of subnetwork 110(2) by upsampling to obtain high resolution features that match the input size of level 2. Level 2 of subnetwork 110(2) can also receive intermediate features from level 1 of subnetwork 110(2), which can be processed and downsampled to the same resolution. Level 2 of subnetwork 110(2) can produce its own intermediate features from these inputs, which can then be input to level 3 of subnetwork 110(2) by downsampling and to level 1 of the next subnetwork (not shown) by upsampling, and so on.

### Model Characteristics

The following section provides some additional details on the processing by object detection model 100. Upon receiving a video having a sequence of frames, alignment 104 can preprocess the sequence of N frames before feeding respective frames into stem layer 106. For instance, one way to align the video frames is with respect to a reference frame, such as the first frame of the video, the last frame of the video, etc. This can be performed using a feature-based method that aligns images by detecting and matching distinctive key-points across images, a deep learning method, etc. Aligning the frames can mitigate the effects of camera motion by stabilizing the background across video frames. Thus, the initial feature maps output by the stem layer 106 represent the respective video frames from the same camera perspective. This can facilitate temporal learning by the individual subnetworks, which can focus on learning to detect foreground objects.

Another aspect of object detection model 100 is that temporal information is fused across frames and feature levels. As described more below, this can enhance detection accuracy and consistency. Conventional approaches tend to downsample video frames and then detect moving objects using low-resolution, high-level features output by the highest layers of the model. In contrast, object detection model 100 propagates temporal information among individual subnetworks and across different levels of the subnetworks starting from the first video frame. As a consequence, the final features processed by the output layer(s) have been subjected to far less information loss than in conventional approaches.

As a further point, reversible connections among individual subnetworks and levels allows for fusion of intermediate feature maps derived from previously-processed frames and the currently-processed frame. The reversible connections can implicitly encode temporal information and propagate the temporal information from subnetwork i (corresponding to the i-th frame) to subnetwork i+1 (corresponding to the (i+1)-th frame) for feature learning. Thus, learning in subnetwork i+1 can benefit from both image appearance features of the (i+1)-th frame and temporal information propagated from previous subnetworks.

Moreover, the reversible connections across multiple levels can allow for “feature disentangling.” During the feature propagation across subnetworks, the information from different levels is gradually separated. Temporal features can be separated from other low-level visual features or high-level global semantics as information propagates through the object detection model 100. Thus, this feature disentangling can enable the temporal features to effectively guide learning in subsequent subnetworks.

As another point, the use of reversible connections allows activations from one subnetwork to be directly recomputed in the subsequent subnetworks. As discussed more below, this can dramatically reduce memory requirements during both training and inference. Because this technique provides efficient encoding and transmission of temporal information from multiple levels and across frames, the reduced memory utilization does not significantly degrade object detection accuracy.

In some implementations, the respective levels of each subnetwork are implemented using ConvNeXt blocks, which is a convolution-based block. (Liu, et al., “A Convnet for the 2020s,” Proceedings of the IEEE/CVF Conference on Computer Vision and Pattern Recognition, 2022, pp. 11976-11986). ConvNeXt blocks can approximate the performance of transformer-based blocks while providing efficiency similar other convolutional blocks. Note, however, that other types of convolutional and/or transformer-based blocks can be employed to implement respective layers of each subnetwork.

### Training

To train object detection model 100, various procedures can be employed. For instance, some implementations can pretrain a single subnetwork with a classification layer on an image classification dataset such as ImageNet. Then, the pretrained weights from that subnetwork can be copied to the other subnetworks for subsequent tuning. Note also that object detection model 100 can be employed for object detection in static images as well as in videos. Once pretrained, detection and/or segmentation data sets can be used to tune the individual weights of each subnetwork, e.g., using a video dataset such as VisDrone-VID. Generally, these tasks can be used to train the object detection model to learn the location as well as classification of various objects.

Some implementations also employ an intermediate supervision approach that employs both a classifier and a decoder, as described more in Cai, et al., “Reversible column networks,” 2022, arXiv preprint arXiv:2212.11696. Briefly, these implementations can help mitigate information loss within the object detection model 100, which can be caused by downsampling across levels within a given subnetwork. A loss function can be computed using a cross-entropy loss for classification and binary cross-entropy reconstruction loss by using the decoder to attempt to reconstruct one or more of the video frames. This can be implemented on a subnetwork-by-subnetwork basis, e.g., each subnetwork can be trained or tuned using a corresponding classification and decoder head for that subnetwork.

### Example Video Frames

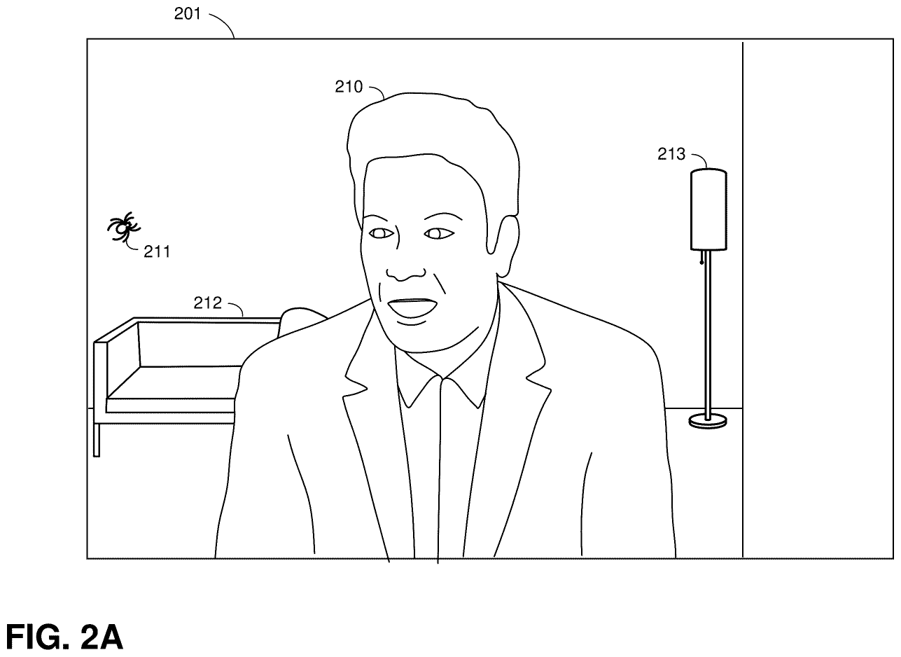

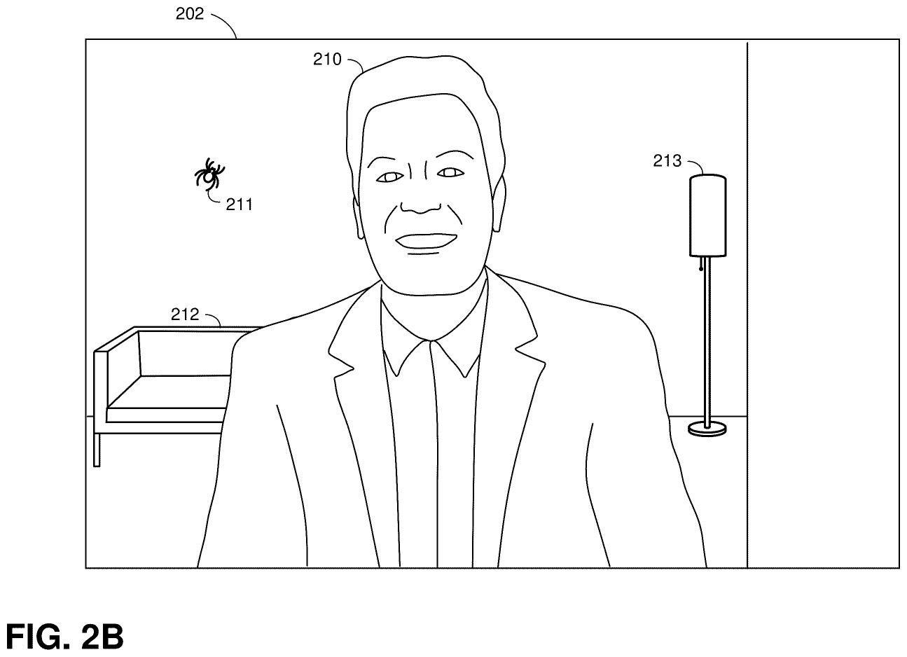

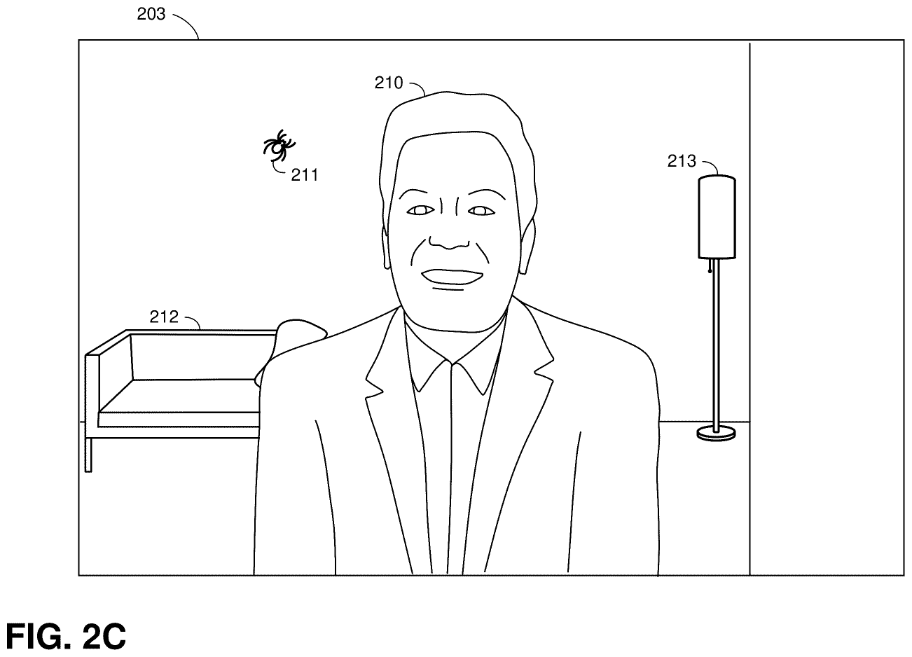

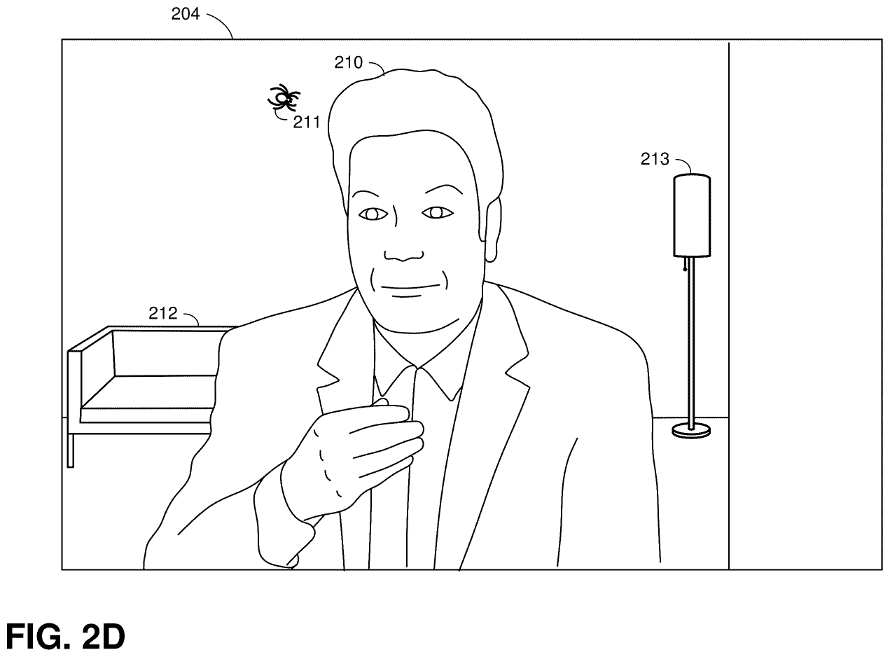

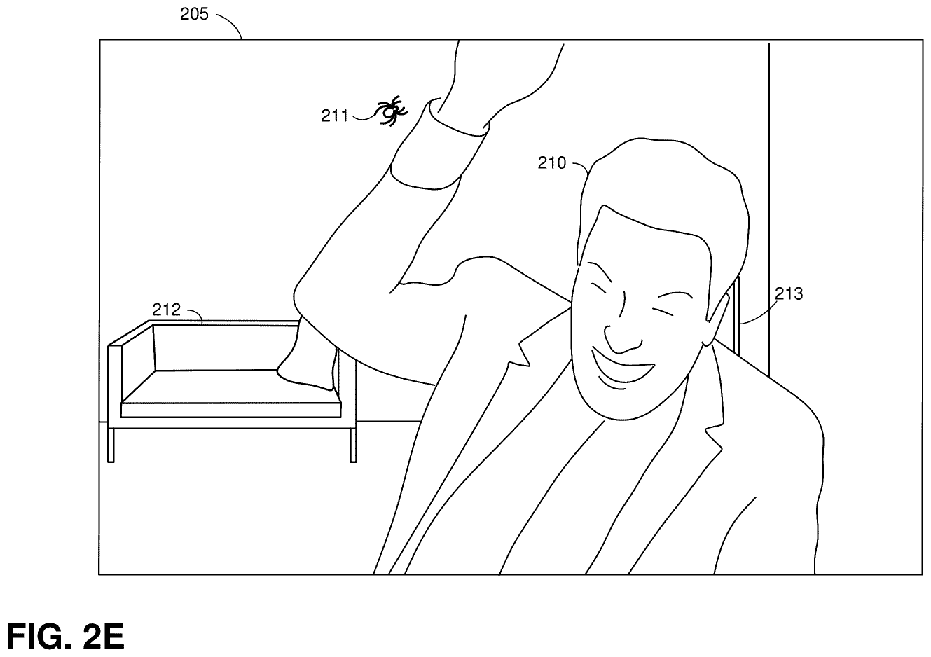

FIG. 2A shows a video frame 201, FIG. 2B shows a video frame 202, FIG. 2C shows a video frame 203, FIG. 2D shows a video frame 204, and FIG. 2E shows a video frame 205. A user 210 is shown in each video frame along with a spider 211, as well as a couch 212 and a lamp 213. The user and spider move across video frames, while the couch and lamp remain stationary.

Note that the spider 211 is relatively small in comparison to the entirety of the video frames. Traditional object detection techniques could have a difficult time detecting the spider, as a result of the small size. If the spider moves quickly and/or is occluded in some frames by another object, this can make detection of the spider even more difficult. The following describes how object detection model 100 can process each of the video frames resulting in a successful detection of the spider.

### Example Processing Sequence

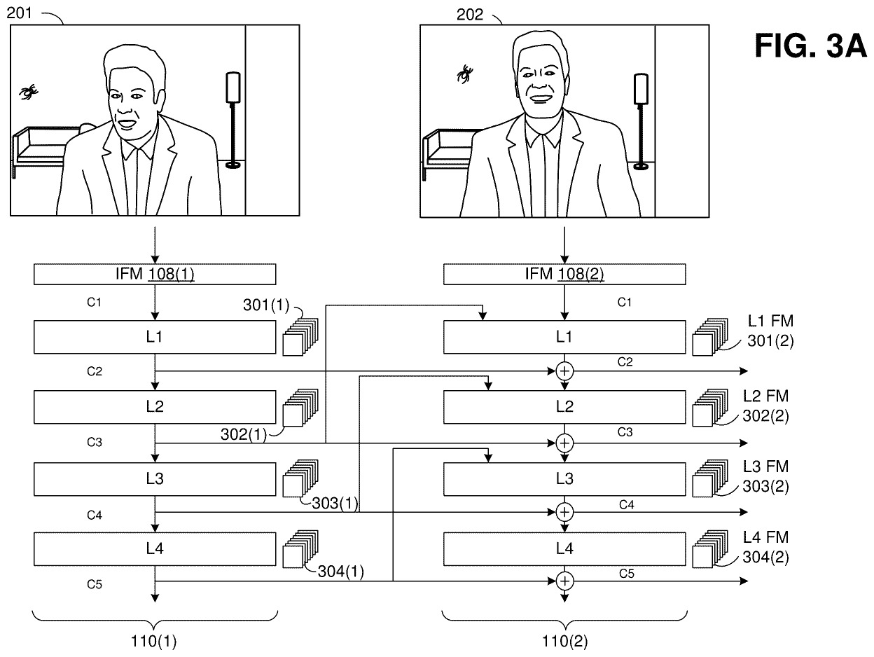

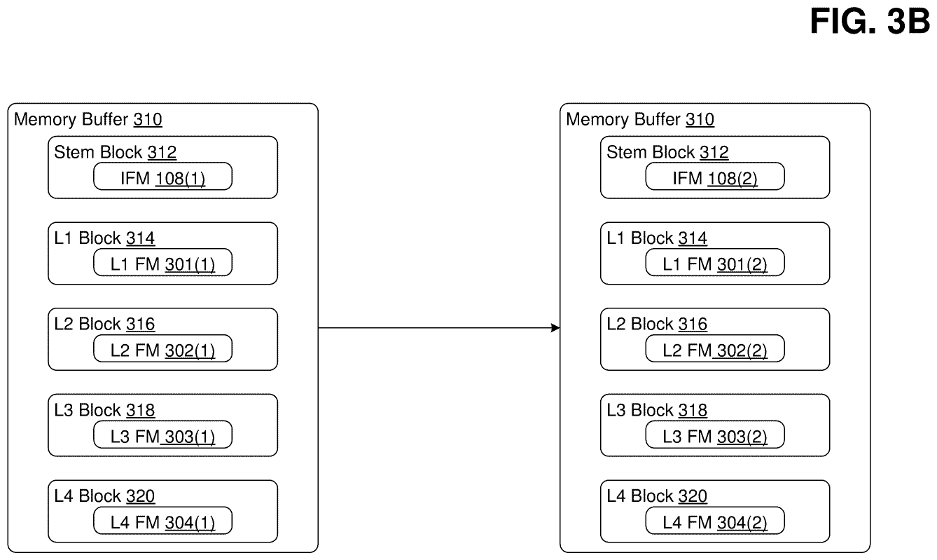

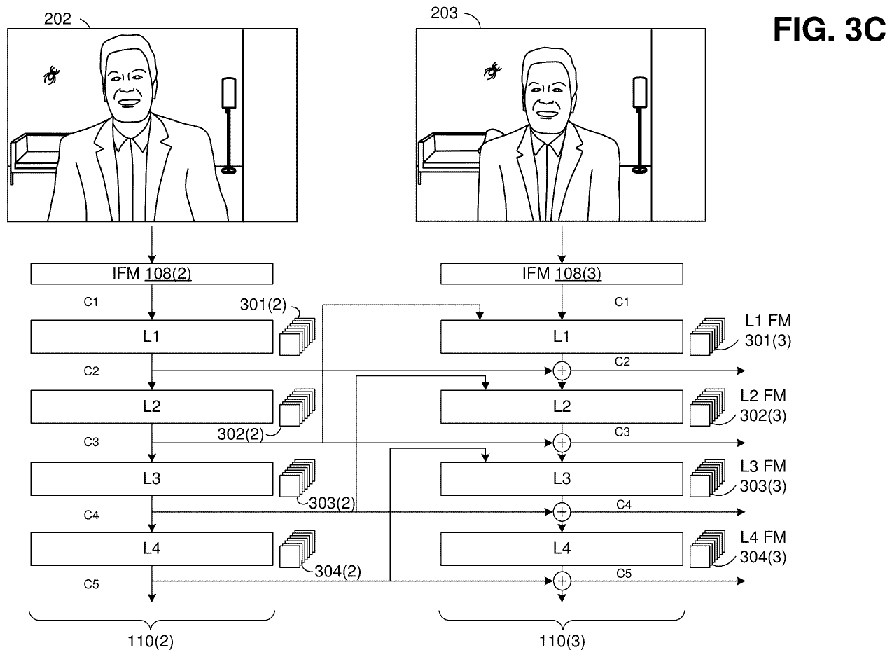

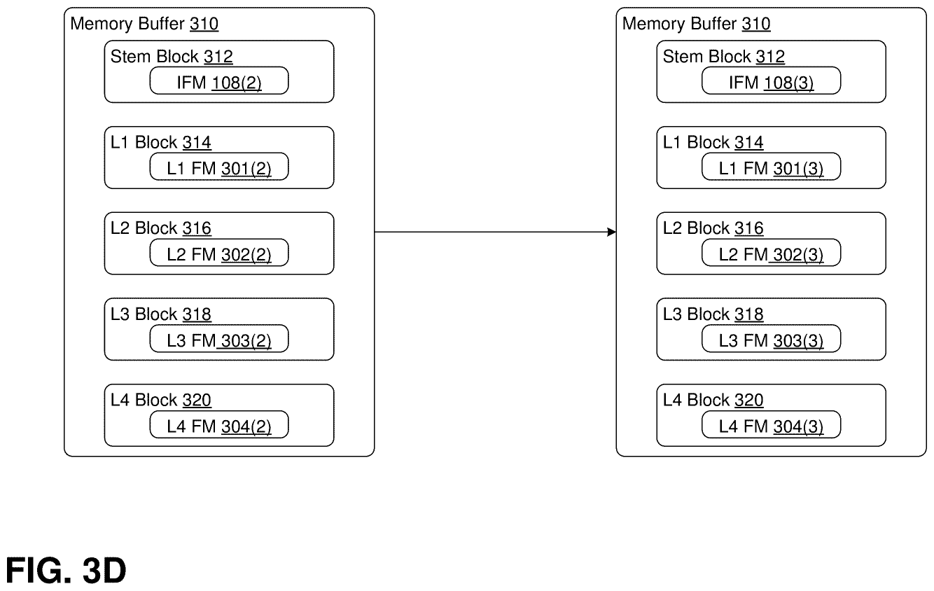

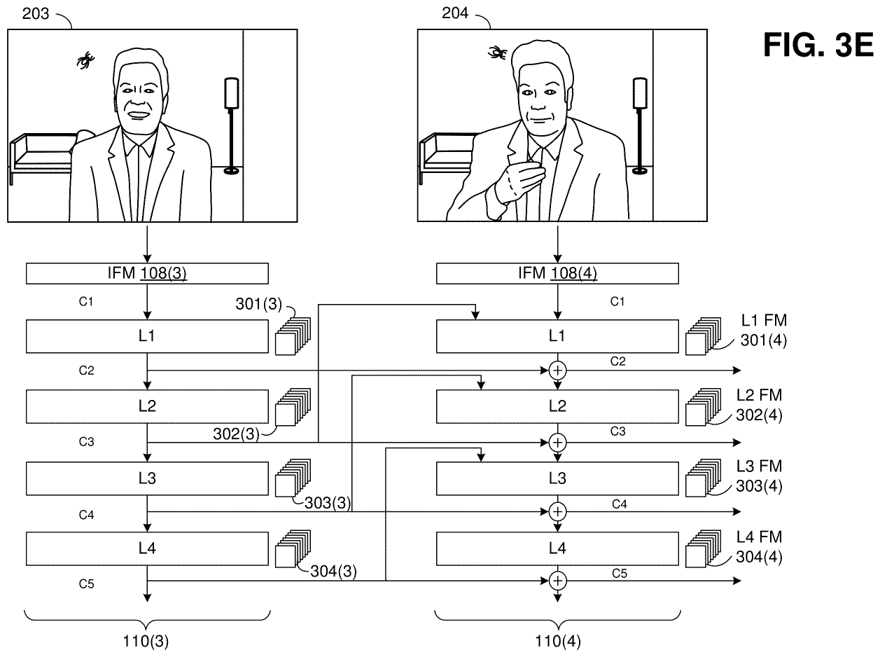

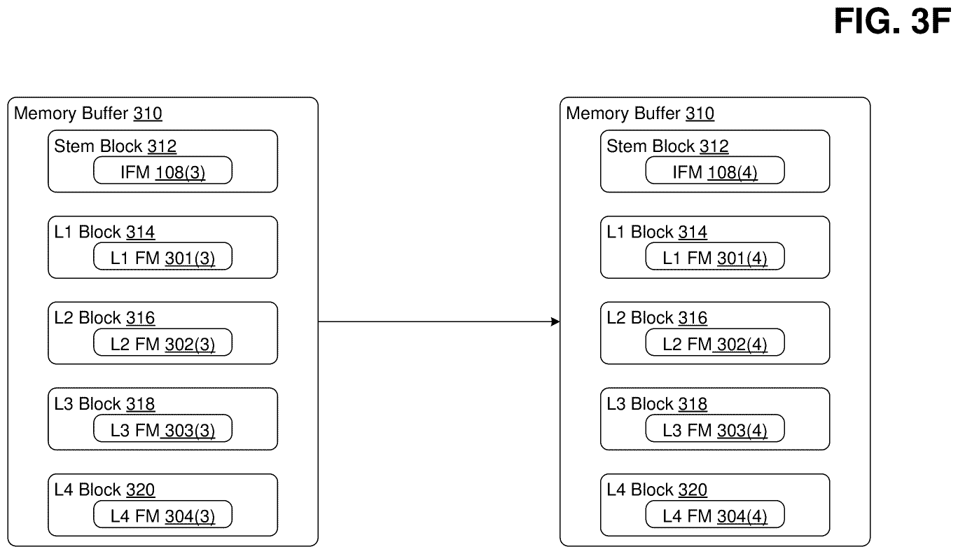

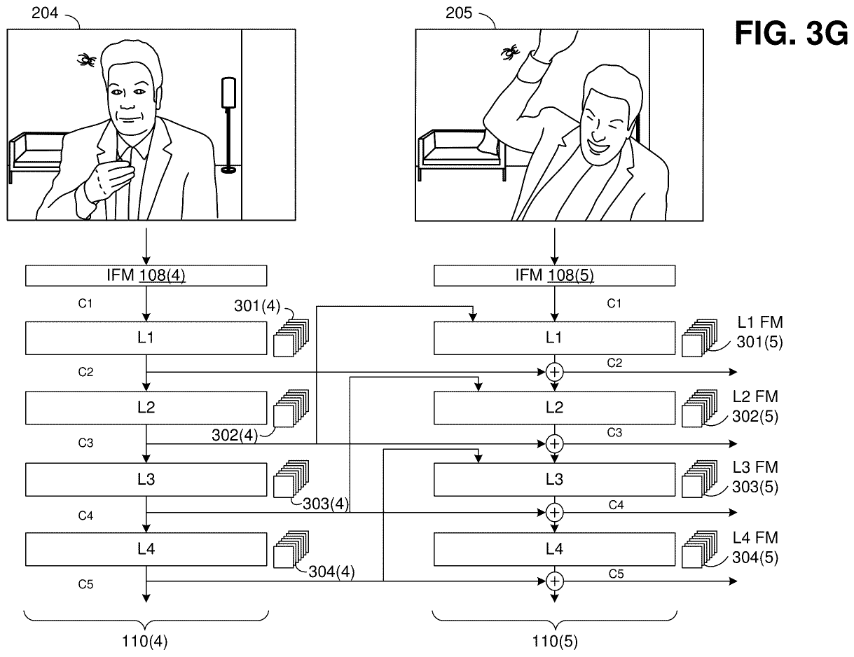

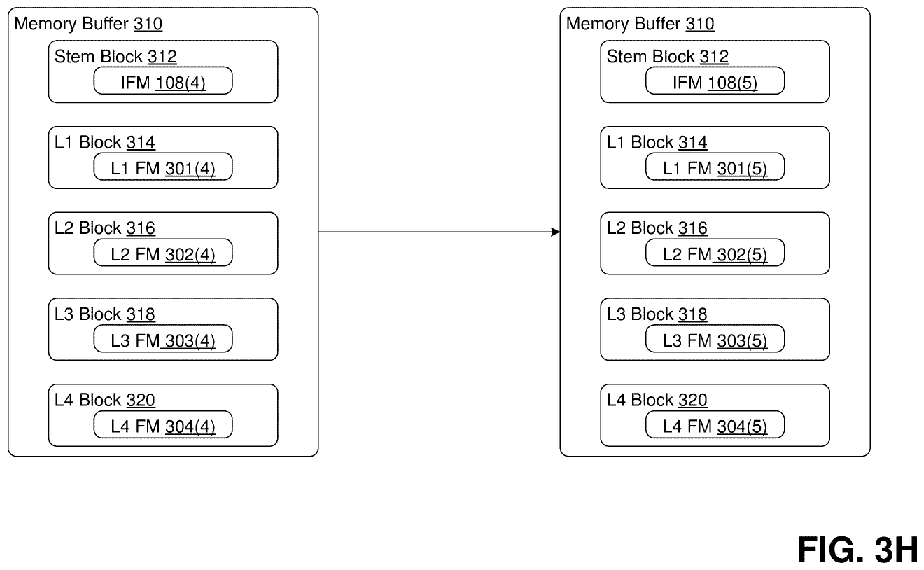

FIGS. 3A through 3H show an example of how object detection model 100 can be employed to process frames 201 through 205 shown in FIGS. 2A through 2E.

In FIG. 3A, frame 201 can be represented by initial feature map 108(1) and frame 202 can be represented by initial feature map 108(2), which can be produced by stem layer 106 as described previously. Subnetwork 110(1) can process initial feature map 108(1) and produce L1 intermediate feature map 301(1) using level L1. Subnetwork 110(1) can produce L2 intermediate feature map 302(1) using level L2, subnetwork 110(1) can produce L3 intermediate feature map 303(1) using level L3, and subnetwork 110(1) can produce L4 intermediate feature map 304(1) using level L4. Each of these intermediate feature maps can be input to subnetwork 110(2), which can produce L1 feature intermediate map 301(2), L2 intermediate feature map 302(2), L3 intermediate feature map 303(2), and L4 intermediate feature map 304(2) based on the input intermediate feature maps as well as initial feature map 108(2) representing frame 202.

FIG. 3B shows a memory buffer 310 with a stem block 312, L1 block 314, L2 block 316, L3 block 318, and L4 block 320. The stem block can be employed to store initial feature maps, the L1 block can be employed to store L1 intermediate feature maps, the L2 block can be employed to store L2 intermediate feature maps, the L3 block can be employed to store L3 intermediate feature maps, and the L4 block can be employed to store L4 intermediate feature maps.

FIG. 3B shows how the respective memory blocks in memory buffer 310 can be overwritten during processing of frame 202. When processing frame 201, the respective memory blocks store respective feature maps used by subnetwork 110(1)—initial feature map 108(1), L1 intermediate feature map 301(1), L2 intermediate feature map 302(1), L3 intermediate feature map 303(1), and L4 intermediate feature map 304(1), respectively. When processing moves to frame 202, the respective memory blocks are overwritten with feature maps utilized by subnetwork 110(2) initial feature map 108(2), L1 intermediate feature map 301(2), L2 intermediate feature map 302(2), L3 intermediate feature map 303(2), and L4 intermediate feature map 304(2), respectively. This process can continue by overwriting intermediate features as each next frame is processed in an iterative manner, as described more below.

In FIG. 3C, frame 202 can be represented by initial feature map 108(2) and frame 203 can be represented by initial feature map 108(3). As noted above, subnetwork 110(2) can process initial feature map 108(2) and produce L1 intermediate feature map 301(2) using level L1, L2 intermediate feature map 302(2) using level L2, L3 intermediate feature map 303(2) using level L3, and L4 intermediate feature map 304(2) using level L4. These can be input to subnetwork 110(3) which can produce L1 intermediate feature map 301(3) using level L1, L2 intermediate feature map 302(3) using level L2, L3 intermediate feature map 303(3) using level L3, and L4 intermediate feature map 304(3) using level L4.

FIG. 3D shows how the respective memory blocks in memory buffer 310 can be overwritten during processing of frame 203. When processing frame 202, the respective memory blocks store respective feature maps used by subnetwork 110(2)—initial feature map 108(2), L1 intermediate feature map 301(2), L2 intermediate feature map 302(2), L3 intermediate feature map 303(2), and L4 intermediate feature map 304(2), respectively. When processing moves to frame 202, the respective memory blocks are overwritten with feature maps utilized by subnetwork 110(3) initial feature map 108(3), L1 intermediate feature map 301(3), L2 intermediate feature map 302(3), L3 intermediate feature map 303(3), and L4 intermediate feature map 304(3), respectively.

In FIG. 3E, frame 203 can be represented by initial feature map 108(3) and frame 204 can be represented by initial feature map 108(4). As mentioned above, subnetwork 110(3) can process initial feature map 108(3) and produce L1 intermediate feature map 301(3) using level L1, L2 intermediate feature map 302(3) using level L2, L3 intermediate feature map 303(3) using level L3, and L4 intermediate feature map 304(3) using level L4. These can be input to subnetwork 110(4) which can produce L1 intermediate feature map 301(4) using level L1, L2 intermediate feature map 302(4) using level L2, L3 intermediate feature map 303(4) using level L3, and L4 intermediate feature map 304(4) using level L4.

FIG. 3F shows how the respective memory blocks in memory buffer 310 can be overwritten during processing of frame 204. When processing frame 203, the respective memory blocks store respective feature maps used by subnetwork 110(3)—initial feature map 108(3), L1 intermediate feature map 301(3), L2 intermediate feature map 302(3), L3 intermediate feature map 303(3), and L4 intermediate feature map 304(3), respectively. When processing moves to frame 204, the respective memory blocks are overwritten with feature maps utilized by subnetwork 110(4) initial feature map 108(4), L1 intermediate feature map 301(4), L2 intermediate feature map 302(4), L3 intermediate feature map 303(4), and L4 intermediate feature map 304(4), respectively.

In FIG. 3G, frame 204 can be represented by initial feature map 108(4) and frame 205 can be represented by initial feature map 108(5). As mentioned above, subnetwork 110(4) can process initial feature map 108(4) and produce L1 intermediate feature map 301(4) using level L1, L2 intermediate feature map 302(4) using level L2, L3 intermediate feature map 303(4) using level L3, and L4 intermediate feature map 304(4) using level L4. These can be input to subnetwork 110(5) which can produce L1 intermediate feature map 301(5) using level L1, L2 intermediate feature map 302(5) using level L2, L3 intermediate feature map 303(5) using level L3, and L4 intermediate feature map 304(5) using level L4.

FIG. 3H shows how the respective memory blocks in memory buffer 310 can be overwritten during processing of frame 205. When processing frame 204, the respective memory blocks store respective feature maps used by subnetwork 110(4)—initial feature map 108(4), L1 intermediate feature map 301(4), L2 intermediate feature map 302(4), L3 intermediate feature map 303(4), and L4 intermediate feature map 304(4), respectively. When processing moves to frame 205, the respective memory blocks are overwritten with feature maps utilized by subnetwork 110(5) initial feature map 108(5), L1 intermediate feature map 301(5), L2 intermediate feature map 302(5), L3 intermediate feature map 303(5), and L4 intermediate feature map 304(5), respectively.

As the intermediate feature maps propagate through the network, movement of user 210 and spider 211 will be conveyed by the intermediate feature maps. Moreover, because the intermediate feature maps are provided at varying levels of resolution, relatively low-level details as well as high-level semantic information can be retained during this processing. Thus, the resulting final feature maps include sufficient high-level features to recognize a relatively small object such as the spider. The resulting final feature maps also include sufficient low-level features to accurately detect the location of the spider, e.g., using a bounding box, and/or to segment the spider using a mask.

### Example System

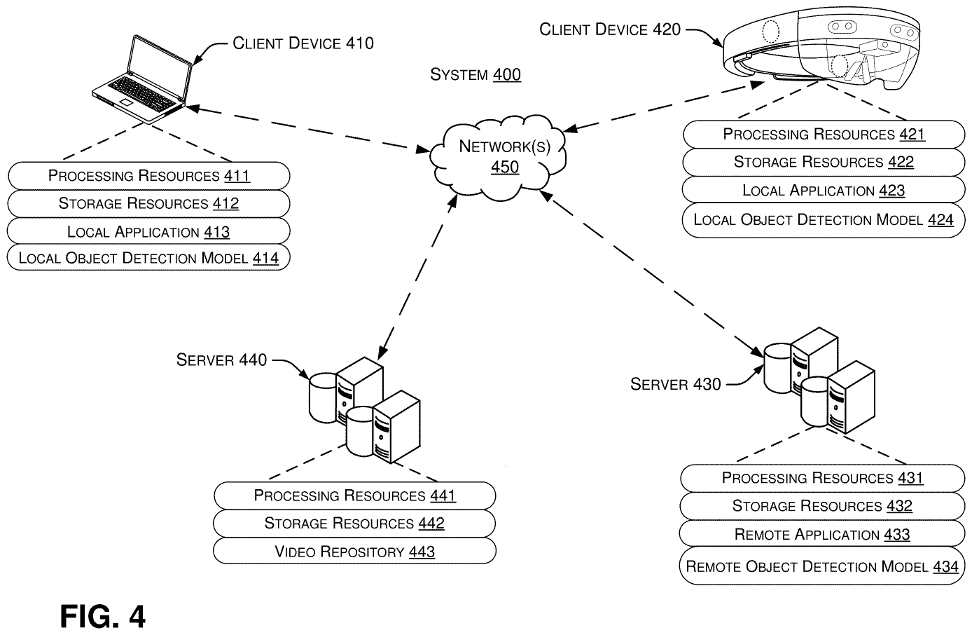

The present implementations can be performed in various scenarios on various devices. FIG. 4 shows an example system 400 in which the present implementations can be employed, as discussed more below.

As shown in FIG. 4, system 400 includes a client device 410, a client device 420, a server 430, and a server 440, connected by one or more network(s) 450. Note that the client devices can be embodied as a mobile device such as smart phones or tablets, stationary devices such as desktops, virtual or augmented reality headsets, etc. Likewise, the servers can be implemented using various types of computing devices. In some cases, any of the devices shown in FIG. 4, but particularly the servers, can be implemented in data centers, server farms, etc.

Client device 410 can have processing resources 411 and storage resources 412, client device 420 can have processing resources 421 and storage resources 422, server 430 can have processing resources 431 and storage resources 432, and server 440 can have processing resources 441 and storage resources 442. Each of these devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client device 410 can include one or more local application(s) 413 and a local object detection model 414. Client device 420 can include one or more local applications 423 and a local object detection model 424. Server 430 can include one or more remote application(s) 433 and a remote object detection model 434. The local and remote object detection models can be respective instances of object detection model 100. Server 440 can host a video repository 443. Each of the object detection models can be implemented similarly to object detection model 100 and/or the various alternatives described elsewhere herein.

As but a few examples of how system 400 can be employed, consider a scenario where video repository 443 on server 440 is populated with satellite videos of the ocean. A boat that appears relatively large in real life could be quite small when viewed in a video produced by a satellite. If a boat capsized in rough waters and an emergency rescue crew were trying to locate the boat, remote object detection model 434 could process the satellite video to identify the boat. As another example, consider a secure area such as a seat of government. Video surveillance cameras on the perimeter could produce video that populates the video repository. Then, the remote object detection model could process the video looking for dangerous items, persons of interest, etc. In these scenarios, local application 413 on client device 410 could be used to query the remote object detection model for objects of interest, e.g., such as the location of a capsized boat.

As another example, consider a user of client device 410 that wishes to use local object detection model 414 for personal use. The user may have a local application that they use to edit home videos. Perhaps the user remembers a specific video where they were hitting a golf ball with friends and would like to find that video. A golf ball is a small, rapidly-moving object that could be difficult to detect. The local object detection model 414 could be used to successfully detect the golf ball in one of the user's home videos.

As another example, consider a user of client device 420. The user may be playing a virtual reality game that renders content on wearable glasses. The user may wish to later identify a small moving object, such as an arrow, from the virtual reality video output by the application. This could be performed by local object detection model 424. Note that, in this case, the video is not necessarily a video of the real world, but rather a virtual reality video.

### Example Method

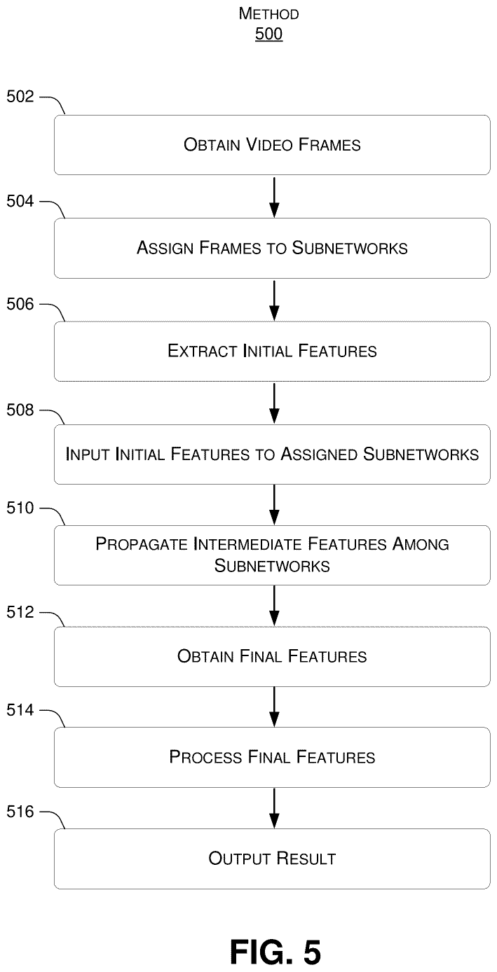

FIG. 5 illustrates an example computer-implemented method 500, consistent with some implementations of the present concepts. Method 500 can be implemented on many different types of devices, e.g., by one or more cloud servers, by a client device such as a laptop, tablet, or smartphone, or by combinations of one or more servers, client devices, etc.

Computer-implemented method 500 begins at block 502, where frames of a video are obtained. For instance, the video frames can be consecutive or non-consecutive frames from a video. The video can be a video of the real world captured by a camera, a video output by an application such as a video game, augmented reality application, or simulation, a video output by a generative machine learning model, etc.

Computer-implemented method 500 continues at block 504, where individual frames are assigned to respective subnetworks. For instance, as described above, the individual frames can each be assigned to column subnetworks having multiple levels, where each column subnetwork has an identical architecture. In other implementations, the subnetworks can have different architectures, e.g., one subnetwork could have transformer blocks, another could have convolutional blocks, a third could have both transformer and convolutional blocks, and so on.

Computer-implemented method 500 continues at block 506, where initial features are extracted from the video frames. For instance, the video frames can be aligned to a reference frame and then processed by a stem layer that outputs the initial features. The stem layer can be a convolutional layer, a transformer-based layer, etc., that processes red, green, and blue pixel data to obtain the initial features.

Computer-implemented method 500 continues at block 508, where the initial features are input to assigned subnetworks. For example, initial features for a first video frame can be input to a first assigned subnetwork, initial features for a second video frame can be input to a second assigned subnetwork, and so on. The initial features can be at a relatively high resolution.

Computer-implemented method 500 continues at block 510, where intermediate features are propagated among the subnetworks. For instance, the intermediate features can be propagated by upsampling the intermediate features from a higher level of a preceding subnetwork to a lower level of the current subnetwork. The propagating can also include downsampling intermediate features from one level of a given subnetwork to a higher level of that same subnetwork. As the levels of the subnetwork get higher, the features can become relatively higher-level, e.g., conveying semantic information about objects in the video frames.

Computer-implemented method 500 continues at block 512, where final features are obtained. For instance, the final features can be obtained from a corresponding subnetwork that processes the final video frame. In the example of FIG. 3G, the final features could be the feature maps output by level L1, level L2, level L3, and/or level L4 of subnetwork 110(5). In other cases, only a subset of the levels of the final subnetwork are used as final features (e.g., L4 only). In other cases, intermediate features output by one or more levels of a preceding subnetwork can also be used as final features.

Computer-implemented method 500 continues at block 514, where the final features are processed to produce a result. For instance, an output layer can perform a classification, object detection, and/or segmentation task on the video. For a classification task, the result can characterize a predominant object in the video, e.g., user 210 in the example video described above. For an object detection task, the result can characterize a location of one or more objects, e.g., bounding boxes around the user 210, the spider 211, etc. For a segmentation task, the result can be a pixel-wise mask indicating which pixels from the final video frame correspond to the spider, the user, etc.

Computer-implemented method 500 continues at block 516, where the result is output. For instance, a classification of the video, a bounding box around a detected object, and/or a segmentation mask of the video can be output. In some cases, the result is output locally, e.g., by storing the classification, bounding box, and/or segmentation mask for subsequent use. In other cases, the result can be output to a user, e.g., by displaying text indicating the classification, displaying a bounding box over a detected object, and/or displaying a segmentation mask for a given object.

### Applications

Several potential applications of the disclosed object detection techniques were described above. However, disclosed techniques can be employed to detect objects for a wide range of applications in addition to those mentioned above. For example, the disclosed techniques can be employed for autonomous systems, e.g., for a robot to identify and avoid flying objects or small obstacles when performing a given task. As another example, the disclosed techniques can be employed for content moderation, e.g., to redact sensitive or private information from a given video. For instance, consider a video of a sporting event where a note is passed between two spectators. The disclosed techniques could be employed to detect and blur or redact the note so that viewers of the sporting event cannot view the contents of the note.

As another example, the disclosed techniques can be employed for disaster response, e.g., by recognizing small moving objects such as people or pets captured from aerial or satellite video cameras. As yet another example, consider an environmental application where videos are used to monitor an ecosystem for a small endangered species, such as a small, fast-moving lizard. As a further example, consider another sports scenario where a coach wishes to analyze the striking power and accuracy of different soccer players from video feeds of soccer matches. In scenarios where the crowd may be wearing colors similar to those of the soccer ball, it could be difficult to detect the ball.

As another example, consider a scenario where the video repository 443 on server 440 includes many different videos from many different sources. The disclosed techniques could be used to build an index of videos based on objects detected therein, for subsequent searching of the videos. For instance, suppose there are many different videos of natural settings, some of which include hummingbirds, others that include small flying insects, etc. The videos could be indexed so that users could search using text prompts for videos having the hummingbirds and/or the insects even if the videos themselves lack metadata identifying the hummingbirds or insects present in the videos.

As another example, consider a scenario where a user wishes to modify the appearance of a small object in a given video. For instance, an original video could be obtained that shows a basketball being shot by a player into a net. The disclosed techniques could be employed to mask off the location of the basketball in each frame. Then, the masked regions could be modified by a generative image model to highlight the basketball for improved visibility, e.g., by making the basketball brighter, larger, luminous, etc. In still further implementations, the trajectory of the basketball could be shown in the modified video by including a “trail” that persists across multiple frames.

As yet another example, consider a scenario where a user wishes to generate a scene in a movie where a small, animated character will fly through a real-life scene. A small ball or other object could be moved through the scene and captured using a camera. Later, that object could be detected using the disclosed techniques and a generative image model could replace the object with the small, animated character. In this manner, a real physical object could be employed to create the trajectory that is subsequently used for the animated character.

### Additional Implementations

As noted previously with respect to FIG. 1, output layer(s) 116 can be employed to perform various downstream tasks based on any of the final feature maps 114(1) through 114(4). For instance, given a classification task, the output layer(s) can be implemented using a fully-connected layer followed by an activation function, such as Softmax, which outputs class probabilities. In some cases, only the highest-level final features (e.g., final feature maps 114(4)) are employed for classification tasks, potentially with a pooling operation such as global average or max pooling applied to these feature maps before the fully-connected layer.

In some implementations, detection tasks are implemented by output layer(s) that utilize the final feature maps from all levels of the final subnetwork. For instance, a neck module such as a Feature Pyramid Network and/or Path Aggregation Network can process the final feature maps. Then, a detection head with one or more convolutional and/or fully-connected layers can output locations and classes of detected objects (e.g., bounding boxes). For segmentation tasks, a U-net decoder can process the final feature maps from all levels of the final subnetwork with a final layer producing a pixel-wise segmentation mask that assigns a class label to each pixel.

Note also that, in the examples described above, each frame was assigned to one subnetwork for feature learning. However, in other implementations, one frame could be assigned to multiple subnetworks, different frames could be shared by a given subnetwork, and so on. Further, in the examples described above with respect to FIG. 1A, each subnetwork was implemented as a column with an identical architecture to the other subnetworks in the model. However, in other implementations, the subnetworks do not necessarily have identical architectures, and the subnetworks are not necessarily represented as columns. This allows for flexible designs to capture diverse and rich temporal feature representations across frames. As also noted, the individual levels of a given subnetwork can be implemented using convolutional layers, transformer layers, and/or combinations thereof.

In addition, the video frames processed by each subnetwork can be consecutive or sparsely sampled across an input video sequence. The selection of consecutive vs. sparse sampling of video frames can depend on specific characteristics of the video being processed and/or objects being detected, such as the video frame rate, the target object ontology, motion patterns, etc. For example, some implementations may uniformly sample video frames at a specified interval, e.g., one of every 10 video frames, every I-frame, every other I-frame, and so on, and assign each sampled frame to a given subnetwork. Other implementations can adaptively sample video frames, e.g., by determining pixel-level differences among frames and sampling video frames that differ from immediately-preceding frames by a threshold.

As another point, some implementations can perform downstream classification, detection, and/or segmentation tasks on the final frame that is assigned to the final subnetwork. In other implementations, the final classification, detection, and/or segmentation can be performed on other frames as well. For instance, by reversing the order in which the frames are input to the subnetworks, some implementations can perform the final downstream task on the first frame.

In addition, note that FIG. 1A shows an example where connections are implemented across consecutive subnetworks. However, in some implementations, skip connections can be employed that connect non-consecutive subnetworks (e.g., from a first subnetwork to a third subnetwork a second subnetwork to a fourth subnetwork, and so on). As another example, vertical skip connections can also be employed, e.g., from L1 in one subnetwork to L3 in that subnetwork. Furthermore, the connections from one level of one subnetwork can vary from those shown in FIG. 1A. For instance, instead of each subnetwork connection only one level from a higher level to a lower level, the subnetwork connections can move up a different number of levels and/or in a different direction (e.g., from lower to higher levels).

### Technical Effect

While some object detection models employ feature propagation, these models tend to learn features for each frame independently. As the features are propagated within the network, they tend to lose information, e.g., by downsampling. Thus, objects are small, blurred, or occluded, this can cause such conventional models to fail at detecting the objects, in part because the features are relatively low resolution and not suited to object detection.

In the disclosed implementations, temporal information is shared among respective subnetworks assigned to process different frames of the video. Furthermore, the temporal information is shared at relatively high resolution, which can guard against information loss that can occur due to downsampling. Thus, within a given subnetwork, feature learning can occur at various levels in a manner that is guided by both visual features of the current frame (e.g., from the stem layer) as well as from temporal features propagated from preceding subnetworks. For small objects, the rich temporal representations developed in the early layers of previous subnetworks can be transferred to subsequent subnetworks with little information loss, greatly enhancing the quality of the final feature map produced by the final sub-network. This early fusion of temporal information across sub-networks brings significant improvements in detection performance under challenging conditions, such as small object sizes and motion blur.

Furthermore, as noted previously, the disclosed implementations can be very memory efficient. A memory buffer with sufficient size to accommodate the feature maps for a single subnetwork can be sufficient to implement the disclosed techniques. When the next frame is processed by a subsequent subnetwork, those features can be overwritten in the memory buffer. This is a significant advantage on resource constrained devices, such as embedded devices, as well as for applications that use massive amounts of video data (e.g., very high resolution, frame rate, etc.).

As a related point, the reversible connections among subnetworks can allow for re-computation of activations instead of storing the activations of each network during forward propagation for reuse during backpropagation. This significantly reduces memory consumption. Furthermore, the feature disentangling across multiple levels enables the disclosed techniques to focus on relevant temporal features for small or occluded objects, improving the overall detection accuracy across object sizes and motion characteristics.

### Device Implementations

As noted above with respect to FIG. 4, system 400 includes several devices, including a client device 410, a client device 420, a server 430, and a server 440. As also noted, not all device implementations can be illustrated, and other device implementations should be apparent to the skilled artisan from the description above and below.

The term “device,” “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore and, when executed, can cause a processor to perform acts. The term “system” as used herein can refer to a single device, multiple devices, etc.

Storage resources can be internal or external to the respective devices with which they are associated. The storage resources can include any one or more of volatile or non-volatile memory, hard drives, solid state drives, flash storage devices, and/or optical storage devices (e.g., CDs, DVDs, etc.), among others. As used herein, the terms “computer-readable media” and “computer-readable medium” can include signals. In contrast, the terms “computer-readable storage media” and “computer-readable storage medium” excludes signals. Computer-readable storage media includes “computer-readable storage devices.” Examples of computer-readable storage devices include volatile storage media, such as RAM, and non-volatile storage media, such as hard drives, optical discs, solid state drives, flash memory, etc.

In some cases, the devices are configured with a general-purpose hardware processor and storage resources. Processors and storage can be implemented as separate components or integrated together as in computational RAM. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), neural processing units (NPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.), microphones, etc. Devices can also have various output mechanisms such as printers, monitors, speakers, etc.

Also note that the devices described herein can function in a stand-alone or cooperative manner to implement the described techniques. For example, the methods and functionality described herein can be performed on a single computing device and/or distributed across multiple computing devices that communicate over network(s) 450. Without limitation, network(s) 450 can include one or more local area networks (LANs), wide area networks (WANs), the Internet, and the like.

### Additional Examples

Various device examples are described above. Additional examples are described below. One example includes a computer-implemented method comprising obtaining video frames of a video, assigning individual video frames of the video to respective subnetworks of a machine learning model, extracting initial features from respective video frames of the video, inputting the initial features to respective assigned subnetworks of the machine learning model, propagating intermediate features among the subnetworks, obtaining final features produced by a final subnetwork of the machine learning model, processing the final features using the machine learning model to produce a result, and outputting the result.

Another example can include any of the above and/or below examples where the method further comprises performing alignment of the video frames prior to extracting the initial features.

Another example can include any of the above and/or below examples where the extracting of the initial features is. performed with a stem layer

Another example can include any of the above and/or below examples where the stem layer includes at least one of a convolutional layer or a transformer layer.

Another example can include any of the above and/or below examples where the stem layer downsamples red, green, and blue pixel data from the video frames when extracting the initial features.

Another example can include any of the above and/or below examples where the respective subnetworks are connected via one or more reversible connections.

Another example can include any of the above and/or below examples where the subnetworks comprise column subnetworks.

Another example can include any of the above and/or below examples where respective column subnetworks have multiple levels.

Another example can include any of the above and/or below examples where the method further comprises within the respective column subnetworks, downsampling the intermediate features when propagating the intermediate features from lower levels to higher levels.

Another example can include any of the above and/or below examples where the method further comprises upsampling the intermediate features when propagating the intermediate features from respective higher levels of individual column subnetworks to respective lower levels of subsequent column subnetworks.

Another example can include any of the above and/or below examples where the method further comprises overwriting, in memory, intermediate features produced by the individual column subnetworks with intermediate features produced by the subsequent column subnetworks.

Another example can include any of the above and/or below examples where at least some of the multiple levels of the column subnetworks comprise convolutional layers or transformer layers.

Another example can include any of the above and/or below examples where the result identifies a moving object present in the video.

Another example can include any of the above and/or below examples where the result identifies a location of the moving object in at least one of the video frames.

Another example includes a processor and a storage medium storing instructions which, when executed by the processor, cause the system to obtain video frames of a video, assign individual video frames of the video to respective subnetworks of a machine learning model, extract initial features from respective video frames of the video, input the initial features to respective assigned subnetworks of the machine learning model, propagate intermediate features among the subnetworks, obtain final features produced by a final subnetwork of the machine learning model, process the final features using the machine learning model to produce a result, and output the result.

Another example can include any of the above and/or below examples where the video frames are consecutive frames.

Another example can include any of the above and/or below examples where the video frames are non-consecutive frames.

Another example can include any of the above and/or below examples where the intermediate features include temporal information that is propagated to subsequent subnetworks of the machine learning model.

Another example can include any of the above and/or below examples where the intermediate features are downsampled within individual subnetworks and upsampled when propagated to subsequent subnetworks over reversible connections.

Another example includes a computer-readable storage medium storing instructions which, when executed by a processing device, cause the processing device to perform acts comprising obtaining video frames of a video, assigning individual video frames of the video to respective subnetworks of a machine learning model, extracting initial features from respective video frames of the video, inputting the initial features to respective assigned subnetworks of the machine learning model, propagating intermediate features among the subnetworks, obtaining final features produced by a final subnetwork of the machine learning model, processing the final features using the machine learning model to produce a result, and outputting the result.

### Conclusion

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A computer-implemented method comprising:
obtaining video frames of a video;
assigning individual video frames of the video to respective subnetworks of a machine learning model;
extracting initial features from respective video frames of the video;
inputting the initial features to respective assigned subnetworks of the machine learning model;
propagating intermediate features among the subnetworks;
obtaining final features produced by a final subnetwork of the machine learning model;
processing the final features using the machine learning model to produce a result; and
outputting the result.

2. The computer-implemented method of claim 1, further comprising:
performing alignment of the video frames prior to extracting the initial features.

3. The computer-implemented method of claim 2, the extracting of the initial features being performed with a stem layer.

4. The computer-implemented method of claim 3, the stem layer including at least one of a convolutional layer or a transformer layer.

5. The computer-implemented method of claim 4, wherein the stem layer downsamples red, green, and blue pixel data from the video frames when extracting the initial features.

6. The computer-implemented method of claim 1, wherein the respective subnetworks are connected via one or more reversible connections.

7. The computer-implemented method of claim 6, the subnetworks comprising column subnetworks.

8. The computer-implemented method of claim 7, respective column subnetworks having multiple levels.

9. The computer-implemented method of claim 8, further comprising:
within the respective column subnetworks, downsampling the intermediate features when propagating the intermediate features from lower levels to higher levels.

10. The computer-implemented method of claim 9, further comprising:
upsampling the intermediate features when propagating the intermediate features from respective higher levels of individual column subnetworks to respective lower levels of subsequent column subnetworks.

11. The method of claim 10, further comprising:
overwriting, in memory, intermediate features produced by the individual column subnetworks with intermediate features produced by the subsequent column subnetworks.

12. The computer-implemented method of claim 8, wherein at least some of the multiple levels of the column subnetworks comprise convolutional layers or transformer layers.

13. The computer-implemented method of claim 1, wherein the result identifies a moving object present in the video.

14. The computer-implemented method of claim 13, wherein the result identifies a location of the moving object in at least one of the video frames.

15. A system comprising:
a processor; and
a storage medium storing instructions which, when executed by the processor, cause the system to:
obtain video frames of a video;
assign individual video frames of the video to respective subnetworks of a machine learning model;
extract initial features from respective video frames of the video;
input the initial features to respective assigned subnetworks of the machine learning model;
propagate intermediate features among the subnetworks;
obtain final features produced by a final subnetwork of the machine learning model;
process the final features using the machine learning model to produce a result; and
output the result.

16. The system of claim 15, the video frames being consecutive frames.

17. The system of claim 15, the video frames being non-consecutive frames.

18. The system of claim 15, wherein the intermediate features include temporal information that is propagated to subsequent subnetworks of the machine learning model.

19. The system of claim 18, wherein the intermediate features are downsampled within individual subnetworks and upsampled when propagated to subsequent subnetworks over reversible connections.

20. A computer-readable storage medium storing instructions which, when executed by a processing device, cause the processing device to perform acts comprising:
obtaining video frames of a video;
assigning individual video frames of the video to respective subnetworks of a machine learning model;
extracting initial features from respective video frames of the video;
inputting the initial features to respective assigned subnetworks of the machine learning model;
propagating intermediate features among the subnetworks;
obtaining final features produced by a final subnetwork of the machine learning model;
processing the final features using the machine learning model to produce a result; and
outputting the result.
